(19) United States
(12) Patent Application Publication
(10) Pub. No.: US 2007/0110922 A1
(43) Pub. Date: May 17, 2007

(54) Alignment Film, Method of Forming the Same, and Liquid Crystal Display Including the Same

(76) Inventors: Soon-Joon Rho, Suwon-si (KR); Kyong-ok Park, Bucheon-si (KR); Jang-sub Kim, Suwon-si (KR); Baek-kyun Jeon, Yongin-si (KR); Phil-kook Son, Busan-si (KR); Jae-chang Kim, Busan-si (KR); Tae-hoon Yoon, Busan-si (KR); Joo-hong Seo, Busan-si (KR); Sung-su Cha, Hapcheon-gun (KR); Sung-Pil Lee, Glmhae-si (KR)

Correspondence Address: Frank Chau, Esq.;P.CHAU & ASSOCIATES, LLC, Suite 501, 1900 Hempstead Turnpike, East Meadow, NY, 11554, US

(21) Appl. No.: 11/557,554

(22) Filed: Nov. 8, 2006

(30) Foreign Application Priority Data
Nov. 16, 2005 (KR) 10-2005-0109901
Mar. 22, 2006 (KR) 10-2006-0026266

(51) Int. Cl. C09K 19/00; G02F 1/1337

(52) U.S. Cl. 428/1.2; 428/1.51; 349/123

(57) ABSTRACT

A method of forming the alignment film includes placing an inorganic target and a substrate in a chamber so that the inorganic target and the substrate are parallel to each other, evacuating the chamber to a first pressure, supplying a discharge gas into the chamber and evacuating the chamber to a second pressure higher than the first pressure. Moreover, the method further includes depositing an inorganic film on the substrate by ejecting inorganic particles from the inorganic target.

This application claims priority from Korean Patent Application Nos. 10-2005-0109901 filed on Nov. 16, 2005 and 10-2006-0026266 filed on Mar. 22, 2006, the disclosure of which is hereby incorporated by reference herein in its entirety.

### BACKGROUND OF THE INVENTION

1. Technical Field

The present disclosure relates to an alignment film, a method of forming the same, and a liquid crystal display including the same.

2. Description of the Related Art

Typically, liquid crystal displays have liquid crystals filled in a space defined between, for example, two transparent insulating substrates, to form a liquid crystal layer with a predetermined thickness. One of the two transparent insulating substrates, includes, for example, a thin film transistor, a pixel electrode which is a field-generating electrode, and an alignment film thereon. In addition, the other transparent substrate includes a color filter, a common electrode which is a field-generating electrode and an alignment film thereon. Moreover, polarization plates are disposed on respective outer surfaces of the two transparent (e.g. glass) substrates.

Various methods of aligning liquid crystals vertically or horizontally with respect to a substrate surface have been developed. However, an alignment film made of a polymer material is used in a majority of liquid crystal displays. For example, conventional alignment films are typically made of polyimide which is stable at high temperatures during manufacturing a liquid crystal display, is adhesive to field-generating electrodes, and has an insulating property to prevent a short circuit between the field-generating electrodes.

Generally, the formation of an alignment film using polyimide is performed using flexographic printing. However, as the size of a substrate used as a substrate for a liquid crystal display increases, it may become difficult to uniformly print an alignment film made of polyimide on a large-sized substrate.

Furthermore, an alignment film made of a polymer compound such as polyimide may be degraded, for example, by light according to environmental conditions, and/or an exposure time, If an alignment film is degraded by light, the material forming the alignment film and a liquid crystal layer, may be decomposed, thereby adversely affecting the performance of liquid crystals.

In addition, a pre-bake process and a curing process are typically involved in the formation of an alignment film using polyimide, thereby increasing the number of processes and causing extended process duration.

Thus, there is a need for an improved alignment film and for a method of forming the same.

### SUMMARY OF THE INVENTION

The exemplary embodiments of the present invention provide a method of forming an alignment film, which is formed to a uniform thickness and is capable of easily controlling a pretilt angle of liquid crystals while exhibiting high light stability.

The exemplary embodiments of the present invention also provide an alignment film.

The exemplary embodiments of the present invention also provide a liquid crystal display including the alignment film.

In accordance with an exemplary embodiment of the present invention, a method of forming an alignment film is provided. The method includes placing an inorganic target and a substrate in a chamber so that the inorganic target and the substrate are parallel to each other, evacuating the chamber to a first pressure supplying a discharge gas into the chamber evacuating the chamber to a second pressure higher than the first pressure and depositing an inorganic film on the substrate by ejecting inorganic particles from the inorganic target.

In accordance with an exemplary embodiment of the present invention, an alignment film is provided. The alignment film is formed by a method which includes placing an inorganic target and a substrate in a chamber so that the inorganic target and the substrate are parallel to each other, evacuating the chamber to a first pressure, supplying a discharge gas into the chamber and evacuating the chamber to a second pressure higher than the first pressure. The method further includes depositing an inorganic film on the substrate by ejecting inorganic particles from the inorganic target.

In accordance with an exemplary embodiment of the present invention, a liquid crystal display is provided. The liquid crystal display includes a first substrate, a second substrate, and a liquid crystal layer interposed between the first substrate and the second substrate and an alignment film interposed between each of the first and second substrates and the liquid crystal layer. The alignment film is formed by a method comprising placing an inorganic target and a substrate in a chamber so that the inorganic target and the substrate are parallel to each other evacuating the chamber to a first pressure, supplying a discharge gas into the chamber evacuating the chamber to a second pressure higher than the first pressure, and depositing an inorganic film on the substrate by ejecting inorganic particles from the inorganic target.

### BRIEF DESCRIPTION OF THE DRAWINGS

Exemplary embodiments of the present invention can be understood in more detail from the following description taken in conjunction with the attached drawings in which:

FIG. 1 is a schematic longitudinal sectional view illustrating a liquid crystal display according to an exemplary embodiment of the present invention;

FIG. 2 is a schematic perspective view illustrating an alignment film(s) according to an exemplary embodiment of the present invention;

FIG. 3 is a flow diagram illustrating a method of forming an alignment film according to an exemplary embodiment of the present invention;

FIG. 4 is a schematic diagram illustrating a sputtering system used in a method of forming an alignment film according to an exemplary embodiment of the present invention;

FIG. 5 is a graph illustrating a pretilt angle of liquid crystals with respect to the internal pressure of a chamber in a method of forming an alignment film according to an exemplary embodiment of the present invention;

FIG. 6 is a schematic diagram illustrating an ion beam treatment system used in a method of forming an alignment film according to an exemplary embodiment of the present invention.

FIGS. 7 through 12 are graphs illustrating process conditions for a method of forming an alignment film according to an exemplary embodiment of the present invention; and

FIG. 13 is a graph illustrating the transmittance with respect to a voltage in liquid crystal display samples manufactured according to Experimental Example of the present invention and Comparative Example.

### DETAILED DESCRIPTION OF THE EXEMPLARY EMBODIMENTS

The present invention may, however, be embodied in many different forms and should not be construed as being limited to the exemplary embodiments set forth herein. Like reference numerals refer to like elements throughout the specification. In the drawings, the thickness of layers and regions are exaggerated for clarity, It will also be understood that when a layer is referred to as being “on” another layer or substrate, it can be directly on the other layer or substrate, or intervening layers may also be present.

The terminology used in the description of the invention herein is for the purpose of describing particular exemplary embodiments only and is not intended to be limiting of the invention. As used in the description of the invention and the appended claims, the singular forms “a”, “an” and “the” are intended to include the plural forms as well, unless the context clearly indicates otherwise. It will also be understood that when a layer is referred to as being “on”, “above” or “upper” another layer or substrate or as being “below”, or “lower” another layer or substrate, it can be directly on or under the other layer or substrate, or intervening layers may also be present. It is noted that the use of any and all examples, or exemplary terms provided herein is intended merely to better illuminate the invention and is not a limitation on the scope of the invention unless otherwise specified.

A single step and a following step included in a single fabrication method disclosed in the exemplary embodiments of the present invention should be interpreted as being sequential, if stated, but not limited to, if unstated. Therefore, it should be apparent to those skilled in the art that the sequence may be changed without departing from the scope of the invention herein.

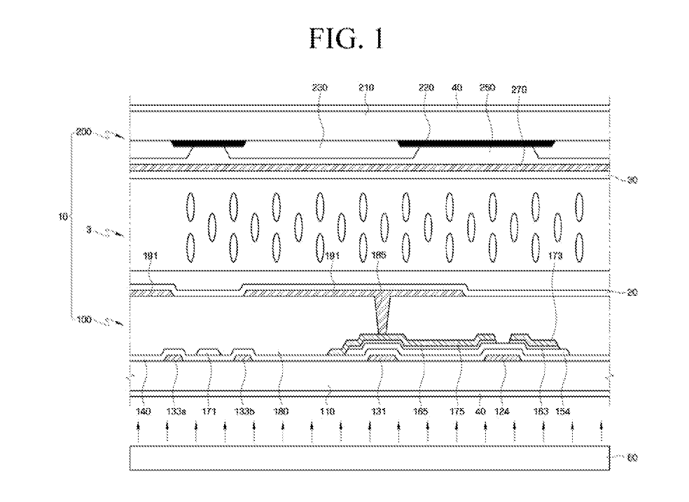

Hereafter, a liquid crystal display according to an exemplary embodiment of the present invention will be described with reference to FIG. 1. FIG. 1 is a schematic longitudinal sectional view illustrating a liquid crystal display according to an exemplary embodiment of the present invention.

Referring to FIG. 1, the liquid crystal display includes a liquid crystal display panel 10 displaying an image using light, first and second polarization plates 40 and 50 polarizing incident light and outputting the polarized light, and a backlight unit 60 generating light and supplying the generated light to the liquid crystal display panel 10.

The liquid crystal display panel 10 may include a first substrate 100 in which, for example, a thin film transistor array is formed, a second substrate 200 facing the first substrate 100, in which, for example a color filter layer is formed, a liquid crystal layer 3 interposed between the first substrate 100 and the second substrate 200, and alignment films 20 and 30, interposed between the first and second substrates 100 and 200 and the liquid crystal layer 3, controlling the initial alignment of liquid crystals, in the liquid crystal layer 3. For example, the alignment films 20 and 30 may include an inorganic material.

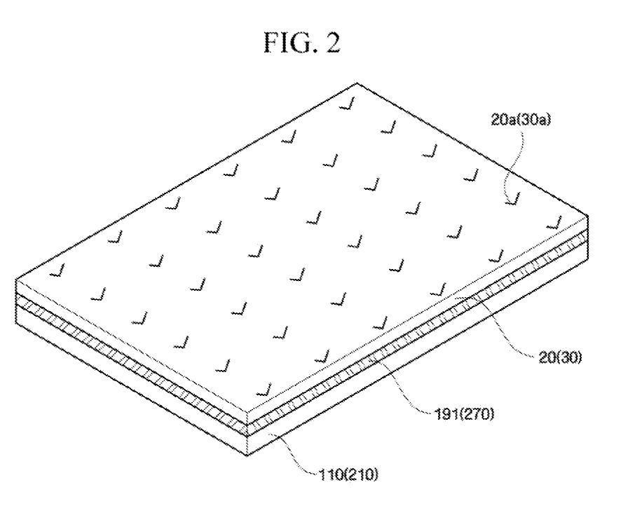

First, the alignment films 20 and 30 contained in the above-described liquid crystal display will be described in detail with reference to FIG. 2. FIG. 2 is a schematic perspective view illustrating the alignment films 20 and 30 shown in FIG. 1.

Referring to FIG. 2, together with FIG. 1, the alignment films 20 and 30 control the alignment states of the liquid crystals constituting the liquid crystal layer 3 in a voltage-off state.

The alignment films 20 and 30 have a concavo-convex surface that allows the liquid crystals to have a predetermined angle (e.g., a pretilt angle) which is substantially perpendicular with respect to the surfaces of the first and second substrates 100 and 200. The liquid crystals can be adjusted to have a desired pretilt angle by, for example, adjusting the arrangement of concaves 20a and 30a and convexes in the concavo-convex surface, and the inclinations of the concaves 20a and 30a. Although the concaves 20a and 30a of the concavo-convex surface are exaggerating illustrated in FIG. 2 for convenience of illustration, they are not substantially visually observed.

Generally, adjacent ones of the liquid crystals tend to be aligned in the same direction. Thus, even when all the liquid crystals are not positioned at the concaves 20a and 30a, the liquid crystals positioned at the concaves 20a and 30a and their adjacent ones are aligned at the same pretilt angle, thereby improving the alignment property of the liquid crystals over the liquid crystal layer 3.

The alignment films 20 and 30 may include an inorganic material. As an inorganic material has improved chemical stability in comparison to an organic material, the alignment films 20 and 30 can have improved light stability in comparison to conventional alignment films including an organic material.

The inorganic material constituting the alignment films 20 and 30 may be a silicon oxide (SiOx) such as silicon dioxide (SiO₂) or silicon monoxide (SiO), metal oxide such as, for example, magnesium oxide (MgO) or ITO (indium tin oxide). Silicon oxide is preferable. Thus, the liquid crystal display panel 10 including the alignment films 20 and 30 made of silicon oxide can have high light stability.

The alignment films 20 and 30 have a predetermined roughness, e.g. surface roughness due to the concavo-convex surface. For example, when the alignment films 20 and 30 are applied to a VA (vertical alignment)-mode liquid crystal display, they may have a surface roughness that allows the liquid crystals to have a pretilt angle of about 80 to about 90 degrees, preferably about 85 to about 90 degrees.

Further in an exemplary embodiment, the alignment films 20 and 30, when they are applied to a TN (twisted nematic)-mode liquid crystal display, may have a surface roughness that allows the liquid crystals to have a pretilt angle of not greater than about 1 degree.

In an exemplary embodiment, when the alignment films 20 and 30 are applied to an IPS (in plane switching)-mode liquid crystal display, they may have a surface roughness that allows the liquid crystals to have a pretilt angle of about 1 to about 10 degrees, preferably about 5 to about 6 degrees.

The alignment films 20 and 30 may have an average thickness of about 500 to about 3,000 angstroms (Å), preferably about 700 Å to about 2,500 Å. When the average thickness of the alignment films 20 and 30 is within the above range, it is easy to control the pretilt angle of the liquid crystals in each area of the liquid crystal layer 3, and it is possible to drive a liquid crystal display with no increase in driving voltage, thereby ensuring no increase in power consumption.

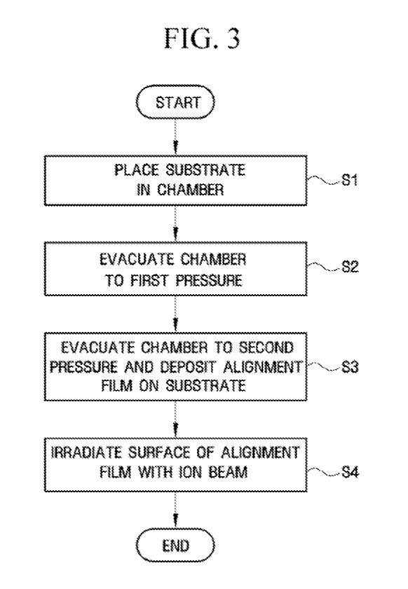

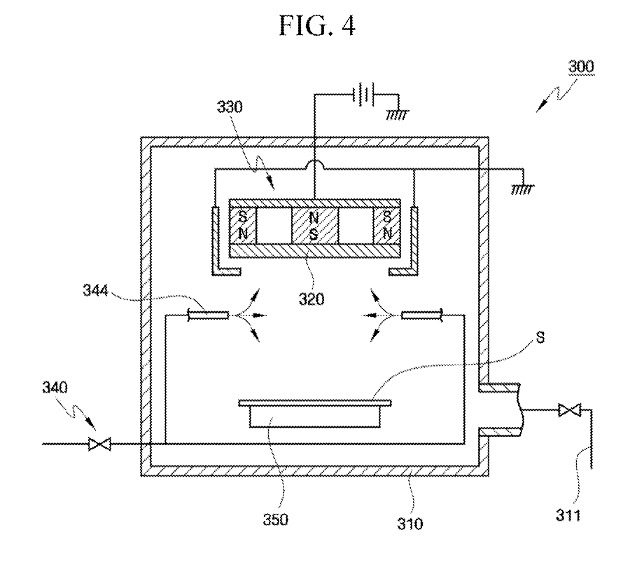

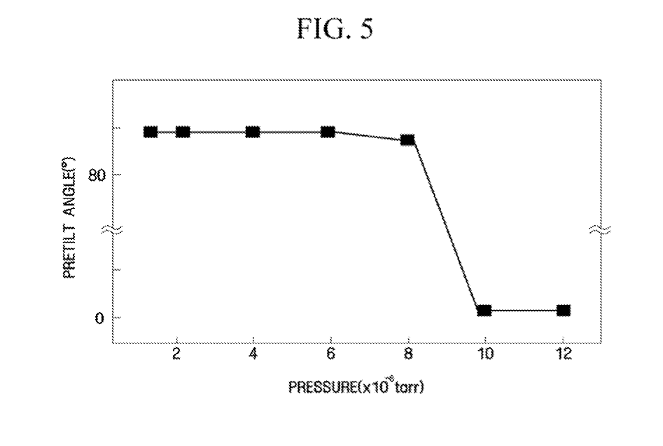

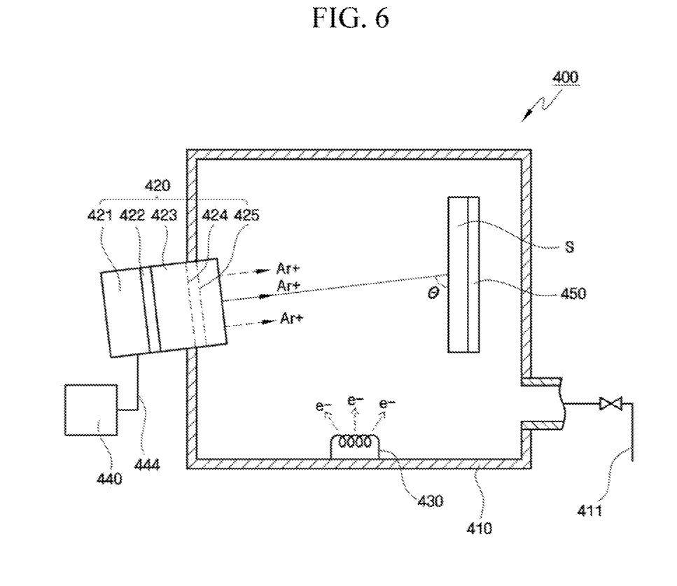

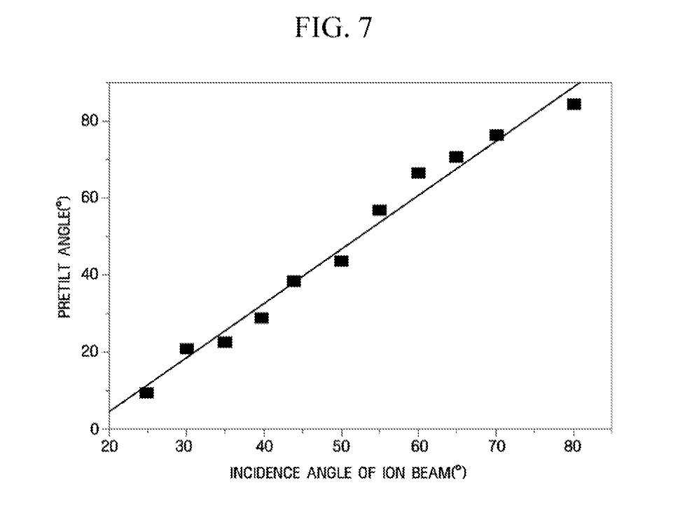

Hereinafter, a method of forming an alignment film according to an exemplary embodiment of the present invention will be described with reference to FIGS. 3 through 12. FIG. 3 is a flow diagram illustrating a method of forming an alignment film according to an exemplary embodiment of the present invention, FIG. 4 is a schematic diagram illustrating a sputtering system used in a method of forming an alignment film according to an exemplary embodiment of the present invention, FIG. 5 is a graph illustrating a pretilt angle of liquid crystals with respect to the internal pressure of a chamber in a method of forming an alignment film according to an exemplary embodiment of the present invention, FIG. 6 is a schematic diagram illustrating an ion beam treatment system used in a method of forming an alignment film according to an exemplary embodiment of the present invention and FIGS. 7 through 12 are graphs illustrating process conditions for a method of forming an alignment film according to an exemplary embodiment of the present invention.

According to an exemplary embodiment of the present invention, an alignment film may be formed using a plasma-based thin film deposition process, e.g., sputtering or chemical vapor deposition (CVD). The formation of an alignment film for a VA-mode liquid crystal display using sputtering will be illustrated hereinunder. However, the exemplary embodiments of the present invention is not limited to the illustrated example.

Referring to FIG. 3, first, a substrate is placed in a chamber (operation S1).

The substrate placed in a chamber of a sputtering, system may be a first substrate in which thin film transistor array is formed on a transparent insulating substrate, such as, for example, a glass or plastic insulating substrate. In addition, a pixel electrode is formed on the thin film transistor array, or a second substrate in which a color filter is formed on a transparent insulating substrate, and a common electrode is formed on the color filter.

Referring to FIG. 4, the sputtering system 300 is configured such that a gas supply manifold 340 supplies a discharge gas into the chamber 310 within a chamber 310 having an exhaust manifold 311. The chamber 310 includes a target 320, a magnetron discharge electrode 330, and a substrate holder 350 supporting a substrate S.

The substrate S is disposed on the substrate holder 350 in the chamber 310 of the sputtering systems 300. At this time, the substrate holder 350 and the target 320 are disposed parallel to each other. Thus, the substrate S disposed on the substrate holder 35 and the target 320 are also parallel to each other.

Next, referring again to FIG. 3, the chamber is evacuated to a first pressure (operation S2).

Referring again to FIG. 4, the chamber 310 is evacuated by the exhaust manifold 311 including, a vacuum pump. At this time, air in the chamber 310 may be discharged until the internal pressure of the chamber 310 reaches no greater than about 8×10⁻⁶ Torr

When the chamber 310 is evacuated to the above pressure, an alignment film suitable for a VA-mode liquid crystal display as shown in FIG. 5 is formed.

Generally, hydrogen (H₂) and oxygen (O₂) coexist in a vacuum state. Oxygen partial pressure is relatively high at a low vacuum state, e.g., when the internal pressure of the chamber 310 is high, compared to at a high vacuum state, e.g., when the internal pressure of the chamber 310 is low. For this reason, the physical properties of a thin film deposited by reaction between a material constituting the target 320 and oxygen may be adversely affected. Thus, when the chamber 310 is in a high vacuum state, the alignment characteristics of an alignment film can be enhanced. At this time, the big vacuum state of the chamber 310 may be maintained for about 1 to about 60 seconds. However, the exemplary embodiments of the present invention are not limited thereto.

Next, referring again to FIG. 3, the chamber is evacuated to a second pressure, and an alignment film is deposited on the substrate (operation S3).

Referring again to FIG. 4, the chamber 310 is evacuated to a second pressure higher than the first pressure using the exhaust manifold 311. At this time, the second pressure may, range from about 1×10⁻² to about 8×10⁻². When the chamber 310 is evacuated to the above pressure, sputtering can be facilitated.

While the chamber 310 is evacuated to the above pressure, the gas supply manifold 340 is operated and a discharge gas is supplied to a space defined between the target 320 and the substrate S via a gas supply pipe 344. The discharge gas is diffused toward the substrate S in front of the target 320. At this time, as a voltage is applied to the magnetron discharge electrode 330, magnetron discharge occurs at the target 320. When the discharge gas is ionized by the magnetron discharge, the ionized gas molecules sputter the target 320. The sputtered target particles fly in the space defined between the target 320 and the substrate S and reach the substrate S to thereby deposit a thin film. When the thin film is formed to a desired thickness, e.g., about 500 Å to about 3,000 Å, voltage application is stopped, and the substrate S is released from the chamber 310.

The discharge gas passing through the gas supply pipe 344 is not particularly limited provided that it is an inert gas. For example, the discharge gas may be an argon (Ag) gas.

A material constituting the target 320 may be silicon oxide (SiOx) such as, for example, SiO₂ or SiO, metal oxide such as, for example, MGO or ITO. For example, silicon oxide may be used.

For example, in the case of forming an alignment film including SiO₂, a SiO₂-containing material may be used as the target 320. In the case of forming an alignment film including SiO, a SiO-containing material may be used as the taret 320.

At this time a radio frequency (RF) power applied to the magnetron discharge electrode 330 may be about 0.3 to about 0.4 Kw, and an internal temperature of the chamber 310 may be about 30° C. to about 230° C.

A thin film (e.g., an alignment film) formed under the above-illustrated conditions may have a surface roughness of about 15 Å to about 30 Å and may allow liquid crystals to have a pretilt angle of about 80 to about 90 degrees with respect to the surface of the substrate S.

According to the above-described plasma-based thin film deposition method, an alignment film is formed in a state wherein a substrate and an inorganic target are parallel to each other. Thus, the alignment film can be formed to a uniform thickness over the substrate, unlike in forming an alignment film while maintaining a predetermined angle between a substrate and a target. Therefore, it is possible to form an alignment film including an inorganic material regardless of a substrate size.

A conventional alignment film deposition method using an inorganic material can be applied to only a small-sized substrate with a size of 2 inch or less. On the other hand, according to the above-described exemplary embodiment of the present invention, an alignment film including an inorganic material can be formed to a uniform thickness on a large-sized substrate as well as on a small-sized substrate. Therefore, with the exemplary embodiments of the present invention, the consumer's desire for large-scale liquid crystal displays may be satisfied.

An alignment film formed by the above-described plasma-based thin film deposition method can allow liquid crystals to have a predetermined pretilt angle. To more precisely control the pretilt angle of the liquid crystals, the alignment film may be surface-treated with an ion beam (see operation S4 of FIG. 3 ).

An ion beam treatment system used for surface treatment of an alignment film is not particularly limited. For example, ion beam treatment system including a cold hollow cathode (CHC) ion source will be illustrated hereinunder.

Referring to FIG. 6, an ion beam treatment system 400 includes a chamber 410, an exhaust manifold 411, and a gas supply machine 440 supplying a discharge gas into the chamber 410. The chamber 410 includes an ion source 420, a neutral filament 430, and a substrate holder 450 supporting a substrate S.

To irradiate a surface of an alignment film with ion beam, first, the substrate S having thereon the alignment film is disposed on the substrate holder 450 in the chamber 410 of the ion beam treatment system 400. Then, the chamber 410 is evacuated by a vacuum pump connected to the exhaust manifold 411. At this time, the chamber 410 may be evacuated to a pressure of about 1×10⁻⁶ to about 8×10⁻⁶ Torr, and may be maintained at a room temperature.

Next, when the gas supply machine 440 connected to the ion source 420 is driven, a discharge gas is supplied to the ion source 420 via a gas supply pipe 444. The discharge gas supplied to a cathode 421 of the ion source 420 causes a glow discharge by positive and negative voltages applied to a discharge voltage generator,

Electrons generated by the glow discharge are induced into a plasma chamber 423 by a potential difference between an electron ejection electrode 422 and the cathode 421. The electrons induced into the plasma chamber 423 collide with the discharge gas to generate plasma ions.

When a positive voltage is applied to the plasma ions, the plasma ions are emitted from the ion source 420 due to acquired ion energy. At this time, the plasma ions are emitted in the form of an ion beam via a grid composed of a plasma grid electrode 424 and an acceleration grid electrode 425. The ion beam emitted from the ion source 420 is irradiated onto the substrate having the alignment film thereon. At this time, inter-ionic repulsion is eliminated by electrons supplied from the neutral filament 430 to the chamber 410.

The ion beam emitted into the chamber 410 is incident onto a surface of the substrate S at a predetermined angle θ. For this, the substrate holder 450 may be appropriately moved before or during irradiating the ion beam emitted from the ion source 420 onto the substrate S so that the ion beam collides with the substrate S at the predetermined angle θ. In other words, as shown in FIG. 7, as the incidence angle of the ion beam with respect to the substrate S is arbitrarily adjusted, a surface of the alignment film can be treated such that liquid crystals arranged on the alignment film may have a variety of pretilt angles.

For example, in the case of forming an alignment film to be applied to a VA-mode liquid crystal display, the surface of the alignment film should be treated so that the pretilt angle of liquid crystals is substantially perpendicular to a substrate surface.

That is to say, when an alignment film is surface-treated with an ion beam to allow liquid crystals to have a pretilt angle of about 85 to about 90 degrees, as shown in FIG. 8, a collision angle between the ion beam and the alignment film may be adjusted so that the incidence angle of the ion beam with respect to a substrate surface is about 30 to about 90 degrees. At this time, the irradiation energy and time of the ion beam are about 60 eV and about 10 seconds, respectively.

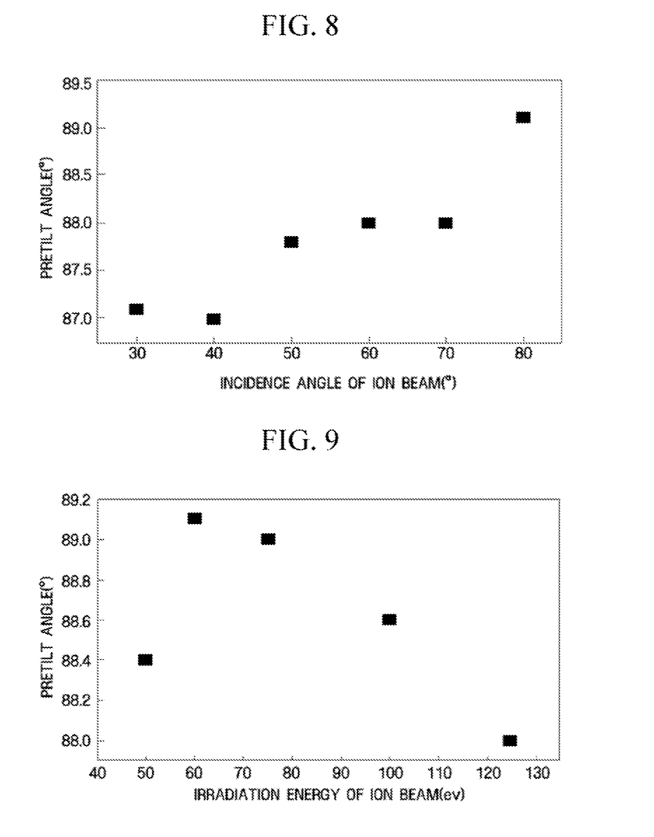

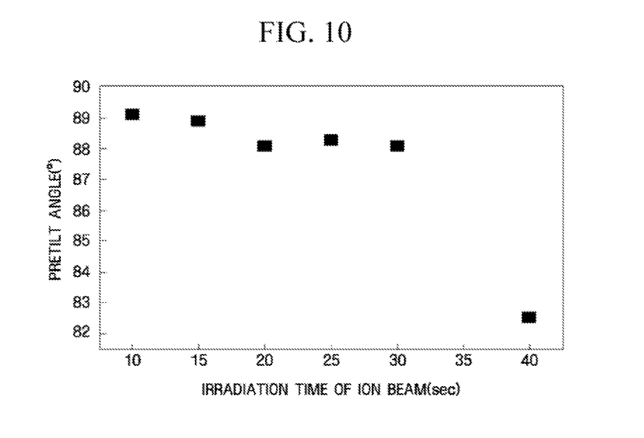

Alternatively, as shown in FIG. 9, the irradiation energy of the ion beam may also be adjusted to about 30 to about 130 eV. At this time, the incidence angle and irradiation time of the ion beam are about 80 degrees and about 10 seconds, respectively. Still alternatively as shown in FIG. 10, the irradiation time of the ion beam may also be adjusted to about 10 to about 30 seconds. At this time, the incidence angle and irradiation energy of the ion beam are about 80 degrees and about 60 eV, respectively.

For example, in the case of forming an alignment film to be applied to a TN- or IPS-mode liquid crystal display, the surface of the alignment film should be treated so that the pretilt angle of liquid crystals is substantially parallel to a substrate surface. That is to say, in the case of a TN-mode liquid crystal display, an alignment film is surface-treated so that liquid crystals have a pretilt angle of not greater than about 1 degree. In addition, in the case of an IPS-mode liquid crystal display, an alignment film is surface-treated so that liquid crystals have a pretilt angle of about 1 to about 10 degrees.

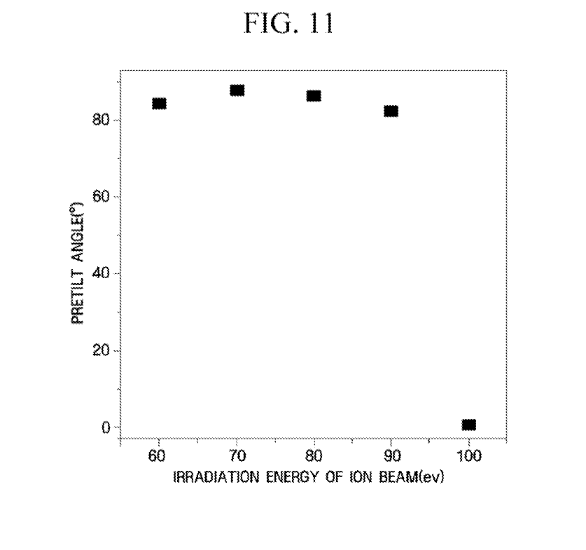

When an alignment film is surface-treated with an ion beam, it is possible to make liquid crystals have a pretilt angle of liquid crystals substantially parallel to a substrate surface by increasing the irradiation energy and time of the ion beam. In other words, as shown in FIG. 11, the irradiation energy and time of the ion beam applied to the alignment film are gradually increased, thereby changing the pretilt angle of liquid crystals from substantially 90 degrees to substantially 0 degrees. At this time, the incidence angle and irradiation time of the ion beam are about 80 degrees and about 1 second, respectively.

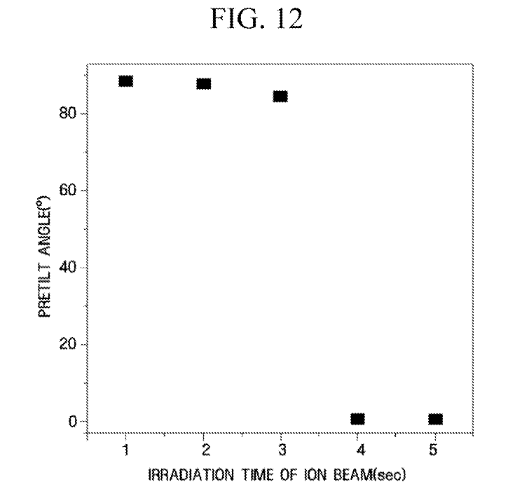

In an alternative embodiment, as shown in FIG. 12, the pretilt angle of liquid crystals may be changed from substantially 90 degrees to substantially 0 degrees by extending the irradiation time of the ion beam. At this time, the incidence angle and the irradiation energy of the ion beam are about 80 degrees and about 70 eV, respectively.

In particular, to surface-treat the alignment film so that the pretilt angle of liquid crystals is substantially parallel to a substrate surface, a linear type ion source is preferably used as an ion source. That is to say, the linear type ion source irradiates ion beams into the substrate surface uniformly at a small incidence angle.

According to the above-described alignment film deposition method, liquid crystals can have a desired pretilt angle by a plasma-based thin film deposition using an inorganic target and an optional ion beam treatment.

Hereinafter, a liquid crystal displayed including an alignment film formed according to the above-described method will be described in detail with reference again to FIG. 1.

Referring back to FIG. 1 illustrating a liquid crystal display according to an exemplary embodiment of the present invention, a first substrate 100 of a liquid crystal display panel 10 includes a substrate 110 made of a transparent insulating material such as, for example, glass, and matrix-type thin film transistor array and a pixel electrode 191 on the substrate 110. The thin film transistor array includes a gather electrode 131, a gate insulating film 140, a semiconductor layer 154, ohmic contact layers 163 and 165, and source and drain electrodes 173 and 175. The pixel electrode 191 is a field-generating electrode made of transparent conductive oxide such as, for example, ITO or IZO (indium zinc oxide).

The pixel electrode 191 is connected to the thin film transistor via a contact hole 185 in a passivation film 180 and receives an image signal voltage. At this time, the thin film transistor is connected to a gate line (131) responsible for scan signal transmission and a data line 171 responsible for image signal transmission and thus permits the pixel electrode 191 to be turned on or off according to the scan signal. Reference numerals 133a and 133b refer to sustain electrode lines. The sustain electrode lines 133a and 133b overlap with the drain electrode 175 to form sustain capacitors enhancing the charge sustain capability of pixels.

A source tape carrier package (TCP) is attached to the source side of the first substrate 100 to apply a data driving signal to the data line 171, and a gate TCP is attached to the gate side of the first substrate 100 to apply a gate driving signal to the gate line.

A second substrate 200 of the liquid crystal display panel 10 includes a substrate 210 made of a transparent insulating material such as, for example, glass, and, below the substrate 210, a black matrix 220 for preventing light leakage, a color filter 230 composed of red, green, and blue components, and a common electrode 270 which is a field-generating electrode made of transparent conductive oxide such as, for example, ITO or IZO.

Alignment films 20 and 30 are respectively formed on inner surfaces of the first and second substrates 100 and 200, e.g., on the pixel electrode 191 and the common electrode 270. As the alignment films 20 and 30 are substantially the same as described above, a repetitive description thereof will not be given.

Meanwhile, with respect to a VA-mode liquid crystal display, liquid crystals constituting a liquid crystal layer 3 between the first and second substrates 100 and 200 may have negative dielectric anisotropy. However, various types of liquid crystals may be used according to the alignment mode of a liquid crystal display.

To seal the liquid crystal layer 3 between the first and second substrates 100 and 200, a sealant is disposed between the first and second substrates 100 and 200.

Meanwhile, polarization plates 40 and 50 are disposed on respective outer surfaces of the liquid crystal display panel 10. The polarization plates 40 and 50 divide incident light into two components perpendicular to each other, and allow only one of the two components to pass therethrough to thereby make a light transmission direction uniform. That is, the polarization plates 40 and 50 allow only light beam of incident light vibrating in the same direction as their polarization axes to pass therethrough, and absorb or reflect the other light beams of the incident light. The transmission axes of the polarization plates 40 and 50 may be perpendicular or parallel to each other.

A backlight unit 60 responsible for light supply to the liquid crystal display panel 10 includes, for example, a light source, a light guide plate, a light control sheet, and optical sheets.

A liquid crystal display according to above-described exemplary embodiment of the present invention includes an alignment film including an inorganic material. Unlike a conventional alignment film including an inorganic material which is applied to only a small-sized liquid crystal display, an alignment film according to exemplary embodiments of the present invention can also be applied to a large-sized liquid crystal display. Thus, a liquid crystal display according to exemplary embodiments of the present invention can be used as a large-sized liquid crystal display, such as, for example, a monitor or a television as well as a small-sized liquid crystal display such as, for example, a cellular phone.

The exemplary embodiments of the present invention will be described in detail through the following concrete experimental examples and comparative examples. However, it should be understood that the experimental examples are for illustrative purposes and that the invention is not limited to the illustrated exemplary embodiments.

### EXPERIMENTAL EXAMPLE

ITO-coated substrates were placed on substrate holders parallel to SiO₂ targets in a chamber of a RF magnetron sputtering system, and the chamber was evacuated to about 10⁻⁶ Torr. Then, the chamber was adjusted to a pressure of about 10⁻² Torr, and an argon gas (purity: about 99.99%) was supplied into the chamber. Sputtering was performed until alignment films were formed on the substrates to a thickness of about 1,000 Å. At this time, the chamber was maintained at a temperature of about 60° C.

Next, the substrates having the alignment films thereon were placed on substrate holders in a chamber of an ion beam treatment system using a cold hollow cathode (CHC) ion source, and the alignment films were surface-treated with an ion beam. At this time, the chamber was adjusted to a pressure of about 4×10⁻⁶ Torr and a temperature of about 60□. While the incidence angle of the ion beam with respect to the surfaces of the substrates was about 80 degrees, the irradiation energy, irradiation time and current density of the ion beam were about 60 eV, about 10 seconds, and about 20 μA/cm² respectively.

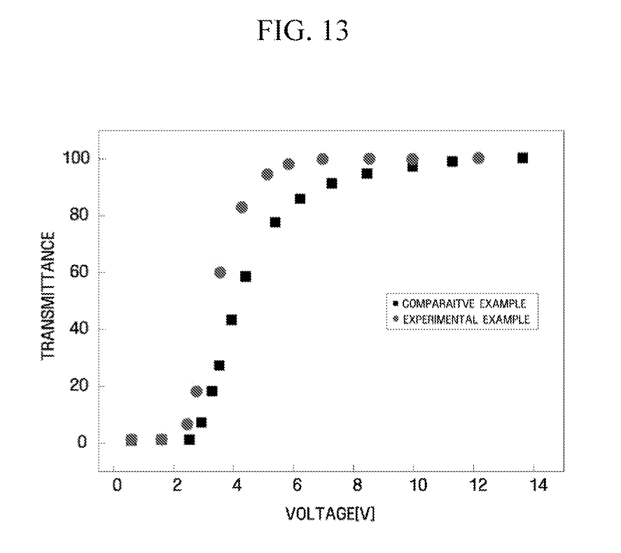

A liquid crystal layer made of MLC-6608 (commercially available from E.M. Merk Corp.) was formed between the substrates having the surface-treated alignment films thereon to complete liquid crystal display sample. The transmittance with respect to a voltage was measured, and the results are shown in FIG. 13.

### COMPARATIVE EXAMPLE

Polyimide AL00010 (commercially available from JSR Electronics) was printed to a thickness of about 1,000 Å on ITO-coated substrates using a flexographic printing process, pre-baked at about 80° C. and cured at about 180° C., to complete alignment films.

A liquid crystal layer made of MLC-6608 (commercially available from E.M. Merk Corp.) was formed between the substrates having the alignment films thereon to complete a liquid crystal display sample. The transmittance with respect to a voltage was measured, and the results are shogun in FIG. 13.

FIG. 13 illustrates the transmittance with respect to a voltage in the liquid crystal display samples manufactured in Experimental Example and Comparative Example. Referring to FIG. 13, the transmittance with respect to a voltage for the liquid crystal display sample of Experimental Example exhibited a similar pattern to that for the liquid crystal display sample of Comparative Example.

The results reveal that an alignment film deposition method of the exemplary embodiments of the present invention can include a lesser number of processes than a conventional alignment film deposition method as it does not require a pre-bake process and a curing process. Thus, the methods in accordance with exemplary embodiments of the present invention offer improved process efficiency, and at the same time, can offer an alignment film having alignment characteristics similar to that of a conventional alignment film.

As described above, according to the exemplary embodiments of the present invention, an alignment film can be formed to a uniform thickness using an inorganic material regardless of a substrate's size, and also exhibits high light stability. Also, the pretilt angle of liquid crystals can be precisely controlled.

Having described the exemplary embodiments of the present invention it is further noted that it is readily, apparent to those of reasonable skill in the art that various modifications may be made without departing from the spirit and scope of the invention which is defined by the metes and bounds of the appended claims.

What is claimed is:

1. A method of forming an alignment film, the method comprising:
placing an inorganic target and a substrate in a chamber so that the inorganic target and the substrate are parallel to each other;
evacuating the chamber to a first pressure;
supplying a discharge gas into the chamber;
evacuating the chamber to a second pressure higher than the first pressure; and
depositing an inorganic film on the substrate by ejecting inorganic particles from the inorganic target.

2. The method of claim 1, wherein the inorganic target comprises silicon oxide (SiOx).

3. The method of claim 1, wherein the depositing of the inorganic film is performed using sputtering or chemical vapor deposition (CVD).

4. The method of claim 3, wherein the first pressure is no greater than about 8×10⁻⁶ Torr.

5. The method of claim 4, wherein the second pressure ranges from about 1×10⁻² to about 8×10⁻² Torr.

6. The method of claim 3, wherein the chamber has an internal temperature in a range of about 30° C. to about 200° C.

7. The method of claim 3, wherein the discharge gas is argon gas.

8. The method of claim 2, wherein the liquid crystals disposed on the inorganic film to have a pretilt angle in a range of about 80 to about 90 degrees with respect to the substrate.

9. The method of claim 1, wherein the inorganic film has a surface roughness in a range of about 15 Å to about 30 Å.

10. The method of claim 1, further comprising irradiating ion beams on the inorganic film after depositing the inorganic film on the substrate.

11. The method of claim 10, wherein the incidence angle of the ion beam with respect to the inorganic film is in a range from about 0 degrees to about 90 degrees.

12. The method of claim 11, wherein the incidence angle of the ion beam with respect to the inorganic film is in a range from about 30 degrees to about 90 degrees.

13. The method of claim 11, wherein in the irradiating of the ion beams, liquid crystals disposed on the inorganic film have a pretilt angle in a range of about 85 to about 90 degrees.

14. The method of claim 11, wherein in the irradiating of the ion beams, liquid crystals disposed on the inorganic film have a pretilt angle no greater than about 0 degrees.

15. The method of claim 11, wherein in the irradiating of the ion beams, the irradiation energy is in a range from about 40 eV to about 130 eV.

16. The method of claim 11, wherein in the irradiating of the ion beams, the irradiation time is in a range from about 10 seconds to about 30 seconds.

17. An alignment film formed by a method comprising placing an inorganic target and a substrate in a chamber so that the inorganic target and the substrate are parallel to each other; evacuating the chamber to a first pressure; supplying a discharge gas into the chamber; evacuating the chamber to a second pressure higher than the first pressure; and depositing an inorganic film on the substrate by ejecting inorganic particles from the inorganic target.

18. The alignment film of claim 17, wherein the inorganic film provides a predetermined pretilt angle for the liquid crystals disposed thereon by ion beans irradiated thereto.

19. A liquid crystal display comprising:
a first substrate, a second substrate, and a liquid crystal layer interposed between the first substrate and the second substrate; and
an alignment film interposed between each of the first and second substrates and the liquid crystal layer, the alignment film formed by a method comprising placing an inorganic target and a substrate in a chamber so that the inorganic target and the substrate are parallel to each other, evacuating the chamber to a first pressure, supplying a discharge gas into the chamber evacuating the chamber to a second pressure higher than the first pressure, and depositing an inorganic film on the substrate by ejecting inorganic particles from the inorganic target.

20. The liquid crystal display of claim 19, wherein the inorganic film provides a predetermined pretilt angle for the liquid crystals disposed thereon by ion beams irradiated thereto.

21. The alignment film of claim 17, wherein the alignment film has a concavo-convex surface.

22. The alignment film of claim 17, wherein the alignment film comprises one of a silicon oxide or a metal oxide.
